(19) United States
(12) Patent Application Publication
(10) Pub. No.: US 2010/0057576 A1
(43) Pub. Date: Mar. 4, 2010

(54) SYSTEM AND METHOD FOR VIDEO INSERTION INTO MEDIA STREAM OR FILE

(75) Inventors: Rainer Brodersen, San Jose, CA (US); Augustin J. Farrugia, Cupertino, CA (US)

Correspondence Address: Apple Inc., 1000 Louisiana Street, Fifty-Third Floor, Houston, TX, 77002, US

(73) Assignee: APPLE INC., Cupertino, CA (US)

(21) Appl. No.: 12/202,891

(22) Filed: Sep. 2, 2008

(51) Int. Cl. G06Q 30/00

(52) U.S. Cl. 705/14.69

(57) ABSTRACT

Systems, methods, and computer readable-media for presenting sub-videos in a media presentation are disclosed. The method includes transmitting a media bundle having a media presentation and a sub-video bundle to a playback device, the sub-video bundle comprising at least one of a video clip and a reference to a video clip, wherein the media presentation includes a plurality of locked segments, unlocking a segment of the media presentation for display to a user by playing a selected unlocking sub-video from the sub-video bundle such that the unlocked segment of the media presentation is playable, and receiving media impressions reported in the form of sub-video playback behavior of the playback device. In one aspect, a media bundle includes at least one of an episode file, a reference to an episode file, metadata, sub-video break locations, and sub-video unlocking information. The playback device can be an online playback device. The online playback device can transfer the media bundle to an offline playback device for playback. A media bundle can further include episode expiration information and sub-video expiration information, such that the playback device will not display any portion of the media bundle when a sub-video in the sub-video bundle is expired or when the episode is expired. In one aspect, at least one segment of the episode is unlocked when the user pays a fee in lieu of playing a sub-video. All or part of the media bundle can be protected by a digital rights management scheme.

### BACKGROUND OF THE INVENTION

1. Field of the Invention

The present invention relates to media content delivery and more specifically to combining advertising content with media content for digital playback.

2. Introduction

Media content providers are exploring new distribution methods for traditional media. Internet and portable media device playback have joined the ranks of broadcast and cable television as major distribution outlets for television shows, user-generated content, movies, radio broadcasts, etc. Content providers are anxious to transition and adapt existing advertising business models for use with the Internet and portable devices.

Advertising partners want statistics demonstrating which shows are popular and which advertisements have been viewed. With videos hosted on a webpage, such statistics are relatively trivial to collect, but when content is downloaded to a portable device, such statistics become difficult to collect and report. The general public is not likely to voluntarily report these statistics in any meaningful numbers. The general public is also not likely to use a cumbersome, confusing, or difficult system to play media on portable devices. If illicitly downloaded media content is easier to use than legally obtained media content, a number of users are more likely to take the path of least resistance. Copyright issues aside, the problem with illicitly downloaded media content is that the content providers have no way to measure the popularity of a piece of media and no way to capitalize on the media by selling advertisement slots.

Accordingly, what is needed in the art is a way to introduce advertisements during media playback and record information about how and when they are viewed.

### SUMMARY OF THE INVENTION

Additional features and advantages of the invention will be set forth in the description which follows, and in part will be apparent from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed are systems, methods, and computer readable-media for presenting sub-videos in a media presentation. The method includes transmitting a media bundle having a media presentation and a sub-video bundle to a playback device, the sub-video bundle comprising at least one of an vide clip and a reference to an video clip, wherein the media presentation includes a plurality of locked segments, unlocking a segment of the media presentation for display to a user by playing a selected unlocking sub-video from the sub-video bundle such that the unlocked segment of the media presentation is playable, and receiving media impressions reported in the form of sub-video playback behavior of the playback device. In one aspect, a media bundle includes at least one of an episode file, a reference to an episode file, metadata, sub-video break locations, and sub-video unlocking information. The playback device can be an online playback device. The online playback device can transfer the media bundle to an offline playback device for playback. A media bundle can further include episode expiration information and sub-video expiration information, such that the playback device will not display any portion of the media bundle when a sub-video in the sub-video bundle is expired or when the episode is expired. In one aspect, at least one segment of the episode is unlocked when the user pays a fee in lieu of playing a sub-video. All or part of the media bundle can be protected by a digital rights management scheme.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example content playback device embodiment;

FIG. 2 illustrates an advertisement insertion scheme;

FIG. 3 illustrates a sample user interface;

FIG. 4 illustrates an example content/advertising download and playback system embodiment;

FIG. 5 illustrates an example content/advertising download and playback method embodiment; and

FIG. 6 illustrates an example media bundle.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without departing from the spirit and scope of the invention.

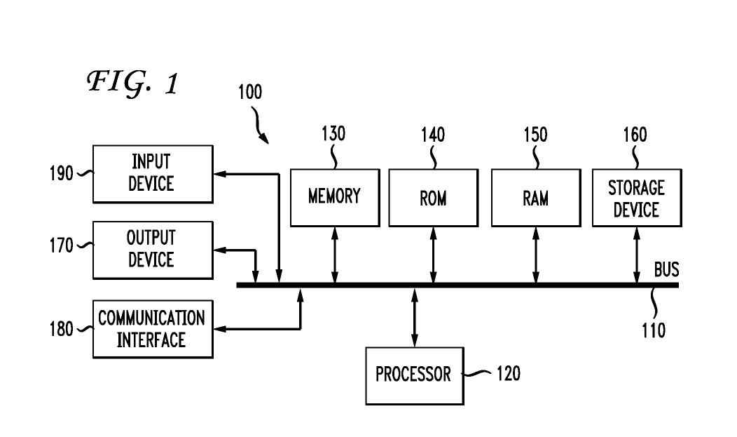

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. A processing unit 120 can include a general purpose CPU controlled by software as well as a special-purpose processor. An Intel Xeon LV L7345 processor is an example of a general purpose CPU which is controlled by software. Particular functionality may also be built into the design of a separate computer chip. An STMicroelectronics STA013 processor is an example of a special-purpose processor which decodes MP3 audio files. Of course, a processing unit includes any general purpose CPU and a module configured to control the CPU as well as a special-purpose processor where software is effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

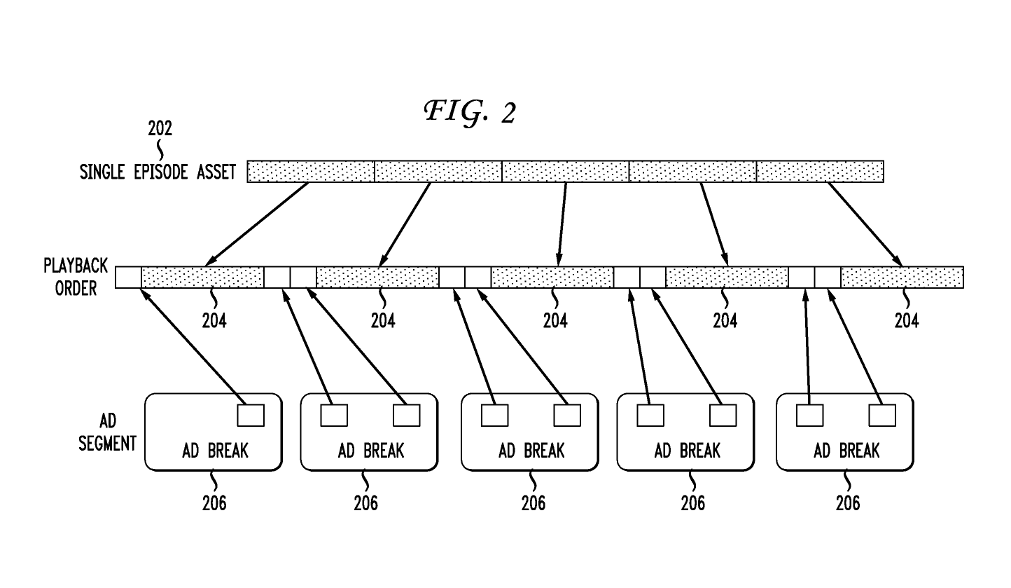

Having discussed the fundamental elements of an example system, the disclosure turns to other principles of the invention. The disclosure discusses the remaining figures in terms of the system embodiment. FIG. 2 illustrates an advertisement insertion scheme in accordance with one exemplary embodiment of the invention. A single episode asset 202 is the target for inserting advertisements. In this example, the system provides a digital version of a broadcast television show as the single episode asset, but can use other audio, video, or multimedia content. In an example embodiment the system provides the single episode asset as a single file with accompanying metadata that indicates locations for episode segments 204 interspersed with ad breaks 206. As shown, an ad break can consist of one or more ads. The system presents a single ad at the initial ad break and two ads at each subsequent ad break. Other scenarios exist, including dynamic ad breaks with variable numbers of ads. A number of factors can influence the number of ads played in each ad break, including a fee paid by a viewer, a fee paid by an advertiser, storage capacity on the playback device, available network bandwidth, etc.

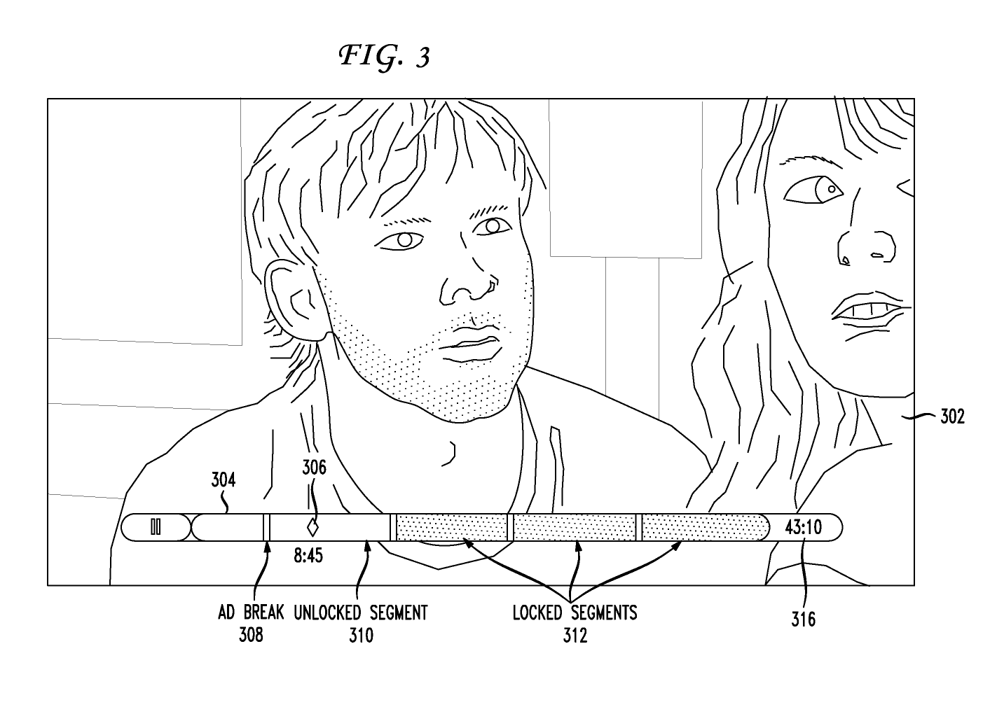

A user can download copies of an episode asset on various and diverse playback devices, such as an Apple iPod, Apple iPod Touch, Apple iPhone, Apple TV, personal computer, etc. The ad breaks for each episode asset are in the same spot for each playback device. In one aspect, the content providers of episode assets dictate where ad breaks are to be shown and how many ads are in each ad break. The system includes ad break locations, ads, end-of-life information for individual ads or for the ad bundle as a whole, and other related information in an ad bundle. The system can store the ad bundle as a part of the episode asset file or as a separate file. End-of-life information is also known as expiration information. When an ad or an ad bundle expires, the system will not play the ad or the ad bundle. The system can use individual bundles of ads, one for each ad break. In one aspect, viewing an ad break 206 unlocks an episode segment 204, as shown in FIG. 3.

FIG. 3 illustrates a sample user interface for a playback system. The system displays the episode on the main display 302 and overlays several user interface elements as needed. While the exemplary display combines the user interface elements over the main display, all or part of the user interface elements may be displayed in a separate area on the display, or may be removed entirely from the main display and can be shown on a remote control device, such as a Harmony 1000 Advanced Universal Remote®, Apple iPod®, a personal computer, smartphone, PDA, etc. The system can display all or some of these elements all the time or can display them only when requested by a user by touching the screen, pressing a button or a key on a keyboard, moving a mouse, etc. The system displays a bar 304 which represents the total playback time of the episode asset. The system displays a cursor 306 or other indicator of current playback temporal location. In FIG. 3, the cursor 306 is at location 8:45, meaning that 8 minutes and 45 seconds have elapsed since the beginning of the episode. While the cursor shown is on top of the bar, another way to show current playback location is to simply display an hour, minute, and second indicator as text in a corner of the main display 302, such as 00:08:45.00. The system indicates ad breaks 308 at various locations along the episode bar 304. While the shown ad breaks 308 are uniform in size, the system can adjust ad break representations on the user interface narrower or wider to reflect their respective durations. As ad breaks are viewed, a segment of the episode associated with that ad break becomes an unlocked segment 310. The unlocked segment can remain unlocked indefinitely, can remain unlocked for a fixed, limited duration, or can remain unlocked for an unknown, but limited duration, such as until the viewer has finished viewing the entire episode.

Segments for which an ad break has not been viewed remain as locked segments 312. In this user interface example, unlocked segments 310 and locked segments 312 are differentiated by shading. Locked segments are shaded and unlocked segments are unshaded. Locked and unlocked segments do not need to be differentiated, but some kind of differentiation makes the user interface more intuitive and user friendly. Locked and unlocked segments can be differentiated by width of the episode bar, by color, by partial or total transparency, texture, etc. At the end of the episode bar is an indicator of total run time 316. The total run time may or may not include the run time of the included ad breaks.

If a user moves the cursor 306 to the right into a locked segment, thus indicating a desire to view a locked segment, the user interface may respond in a number of ways. One alternative is to reject the movement and return the cursor to the original position. The rejection can include playing a chime or popping a message up on the display. Another alternative is to jump back to the corresponding unlocking ad break, play the ad break to unlock the desired segment, and then jump forward to the temporal location to which the user wanted to advance. The cursor can either remain at the location where the user wanted to advance while the ad break is played, or the cursor can jump backward to the ad break then jump forward to the intended location. Yet another alternative is to allow the user to view the content at the indicated location, but at the next ad break, play the ad break to unlock the already partially viewed locked segment and play the ad break to unlock the next locked segment. Other variations exist and may be implemented as needed based on customer usage habits, playback device capabilities, or other factors.

A viewer may click on the cursor 306 to grab it and slide it across the bar 304 to scan to a desired location. In one aspect, respective still frames are shown on the main display 302 indicating what episode content is at the cursor location. The system can display these still frames even when scanning the cursor through locked segments 312. The system can also display still frames for ad breaks.

In a typical usage scenario, a user watches the episode asset just like broadcast television; each segment of the episode is followed by an ad break. While the traditional delivery of ad breaks is familiar, the present system provides alternatives to traditional presentation of advertisements. For example, a user can opt to view all the ad breaks and unlock the entire episode asset before viewing any episode segments at all. This way the user can watch the entire episode without interruption or distraction.

In one aspect, ad breaks can be mandatory or optional. For example, a content provider can make the first ad optional to provide incentive for the viewer to become engrossed in the show. Once this happens, he or she is more likely to view the remaining ads to unlock the rest of the show. In a typical television show episode, the system shows a short (1 or 2 minute) segment known as a teaser in the beginning to set up or introduce some element of the plot before the substance of the story plays out. The ad break between the teaser and the first larger portion of the episode can be made optional. A first ad break before any episode content can be optional as well. The system can include an optional flag in the ad break itself when packaging the ad bundle or can simply unlock the first two segments to allow a user to freely skip around. The system can display ad breaks with an optional flag with some indication that they are optional, such as shading or a different color.

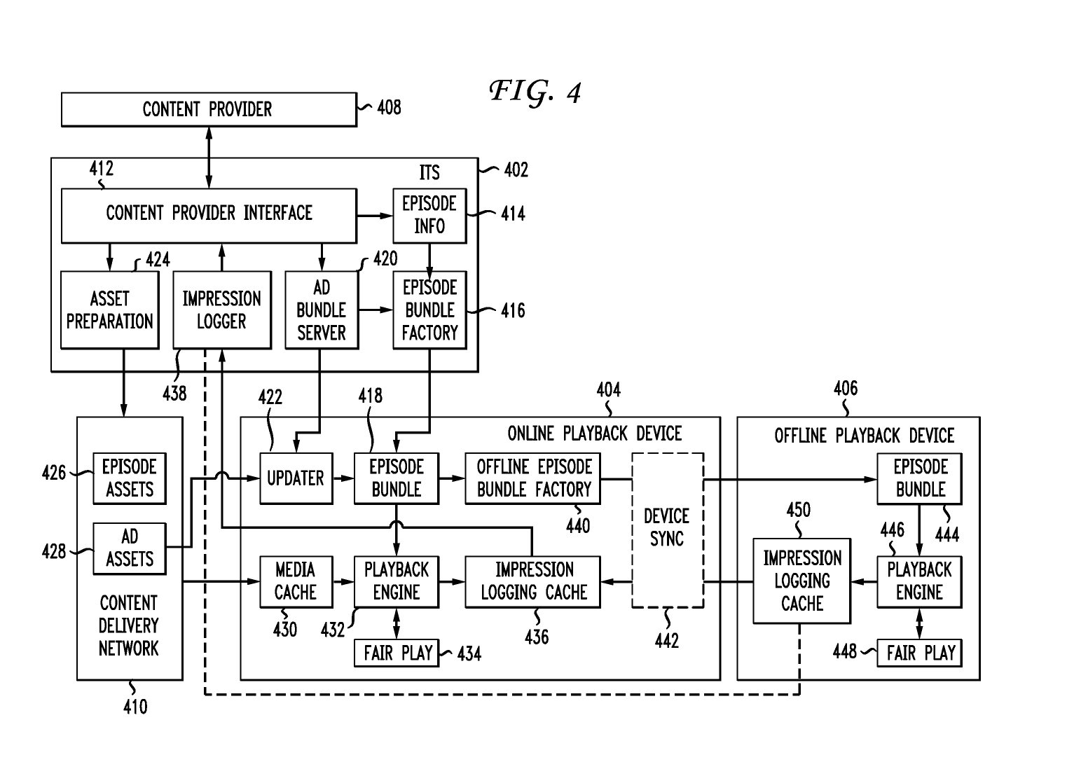

FIG. 4 illustrates an example system embodiment in accordance with the invention. A portal 402, or online store such as the iTunes Store or Real Rhapsody, interfaces with an online playback device 404, such as a personal computer, Apple iPhone, etc. An online playback device is connected to a local network or to the Internet. Some typical examples of online playback devices are a personal computer with iTunes software installed, a PDA with a music subscription account, and an Apple iPhone with iTunes Wi-Fi Music Store software. An online playback device 404 can further interface with an offline playback device 406. One example of such a pairing of devices is a personal computer with iTunes software installed (the online playback device) that syncs with an iPod Classic (the offline playback device). The iPod Classic has no networking abilities, but it can sync with a computer to receive episodes from the portal 402. A content provider 408, such as NBC, CBS, CNN, etc., can access the portal 402 through a content provider interface 412 to upload and manage episode assets. Content providers also include independent or small media producers, or motion picture producers. Episodic video content generated by individuals or small groups can be used as well as content from large television and entertainment studios. Additionally, non-episodic video content such as feature length motion pictures can be segmented into quasi episodes for purposes of the invention. The content provider interface 412 can be a web-based interface, a dedicated software client, or any other suitable interface. Content providers 408 supply episode information 414 through the content provider interface 412. The system transfers episode information 414 to the episode bundle factory 416. Episode information includes metadata, duration, expiration information, etc. Content providers also provide ad bundle information to the ad bundle server 420. The ad bundle server 420 feeds information about individual ads, ad breaks, expiration information, etc. to the episode bundle factory 416. The portal 402 transfers the episode bundle 418 generated by the episode bundle factory 416 to the online playback device 404, typically when a user requests or purchases a particular episode.

Content providers 408 upload the episode asset to an asset preparation module 424. The asset preparation process prepares different formats of episode assets 426 and ad assets 428 for playback on different devices. For example, the asset preparation module transcodes a lower resolution version for an iPod Nano and a higher resolution version for an Apple TV, and the maximum resolution for a high definition digital video recorder. Content providers can also provide authorization for reproduction and storage of their episode assets 426 on a content delivery network 410, such as that provided by Akamai, for efficient and quick distribution of episode assets. Ad providers may provide authorization as well, but advertisers are less likely to be protective of their advertisement as long as it is viewed. The ad bundle server 420 communicates with an updater 422 in the online playback device 404. The updater 422 verifies expiration information and retrieves new ad assets 428 and/or new episode 426 assets if corresponding assets stored on the online playback device 404 are expired. The updater 422 inserts the new ad assets and/or episode assets into the episode bundle 418. The ad assets and episode assets may be included themselves or links to their locations online may be included. The online playback device 404 includes a media cache 430 which retrieves episode assets and ad assets from the content delivery network 410 for stored episode bundles 418.

The playback engine 432 takes an episode bundle 418 and retrieves the correct media from the media cache 430 for output to a user. First, any protected content is passed through a Digital Rights Management (DRM) module 434, incorporating technology such as FairPlay by Apple or DVB-CPCM by the DVB Project. When the DRM module 434 authenticates the media and authorizes the user to view the media content, the playback engine 432 outputs the media to a user and records information about the playback in the impression logging cache 436. The impression logging cache 436 records information such as the identity of a viewer and identity of media viewed, when the content was viewed, how many times the content was viewed, etc. The impression logging cache 436 reports this information to the impression logger 438 in the portal 402. In cases where the online playback device 404 cannot communicate with the portal 402, the impression logging cache 436 can serve as an intermediate storage. When communications are reestablished, the cache 436 uploads any previously unreported impression logs, including those gathered before and during the period of noncommunication. Reporting can be done at some periodic interval or in real time as media is being viewed. Content providers 408 can view the impression logger 438 data through the content provider interface 412. This allows content providers to see how many people have viewed each piece of media content, how often it has been viewed, etc. These metrics are invaluable to both advertisers and content providers.

Offline playback device 406 can be considered an extension of online playback device 404, since the offline playback device 406 must go through an online device at some point to obtain episodes and ads to play back. Online devices, in contrast, get information directly from the portal 402 through the Internet or through a local network.

In the case of offline playback devices, the offline episode bundle factory 440 in the online playback device downloads an episode bundle 418, complete with episode assets 426 and ad assets 428 and assembles it into an offline package. The offline package is synchronized by a device synchronizer 442 to the offline playback device 406 as an episode bundle 444. Much like the online playback device, the offline playback engine 446 retrieves an offline episode bundle 444 for output to a user. Any protected content is passed through a DRM module 448 such as FairPlay. When the DRM module 448 authenticates the media and authorizes the user to view the media content, the offline playback engine 446 outputs the media to a user and records information about the playback in the impression logging cache 450. The impression logging cache records information like who watched which media, when it was watched, how many times it was watched, etc. The impression logging cache 450 reports this information to the impression logging cache 436 in the online playback device 404 which reports the information to the impression logger 438 in the portal 402. Reporting is performed when the offline playback device 406 is synced with the online playback device 404 by synchronizer 442. Content providers 408 can view the impression logger 438 data through the content provider interface 412.

When the offline playback device 406 syncs with the online playback device 404, the updater 422 can check for, download, and sync new ads to replace any ad assets which have expired or are about to expire. Additionally, the updater 422 can be linked with a user profile to provide specifically targeted ads to the intended viewer. For example, the ads sent to a teenager's iPod can be completely different from the ads sent to an adult's iPod, even if they are both downloading the same episode asset.

The offline playback device 406 can be a device that connects only intermittently, such as a device with wifi that a user can disable. Examples of such devices include a PDA or a portable media player with wifi, such as a Palm TX®, Nintendo DS Lite®, Apple iPod Touch®, or Apple iPhone®. In these cases, the offline playback device can temporarily function as an online playback device and transfer logging information immediately to the online store 402 after establishing a network connection, as shown by the dashed line between the impression logging cache 450 and the impression logger 438.

In one aspect, the episode asset is fixed length, with fixed ads, and fixed positions. In another aspect, the ads are dynamic, the number of ads is variable, their positions in the content changes, etc. A fixed episode bundle can be converted to a more dynamic bundle with a mere change in metadata or episode info 414 to indicate when, where, and what to play during ad breaks. The system can base dynamic bundles on user profile information, information about the user's location, the time of day, the current activity of the user, collective user profiles of multiple users, the type of playback device, etc.

In one aspect, a user purchases the episode ad-free. The same episode asset is provided to a purchasing user and a user who watches the episode for free with ads. The only difference is that the ad bundle server returns an empty set of ad assets or returns nothing. That is to say that the purchased and ad-supported episodes are the same file or asset. A user can pay to view an episode completely ad-free or can pay to remove a certain number or percentage of ads in a tiered system. Multiple tiers or levels of ad content can be provided on a sliding price scale. The system is expandable for future ad presentation models consistent with the principles described herein.

The episode bundle in progress can be transferred between devices (such as between online playback devices), but in most typical use scenarios, other devices can simply download the same content and the user can watch a handful of advertisements again.

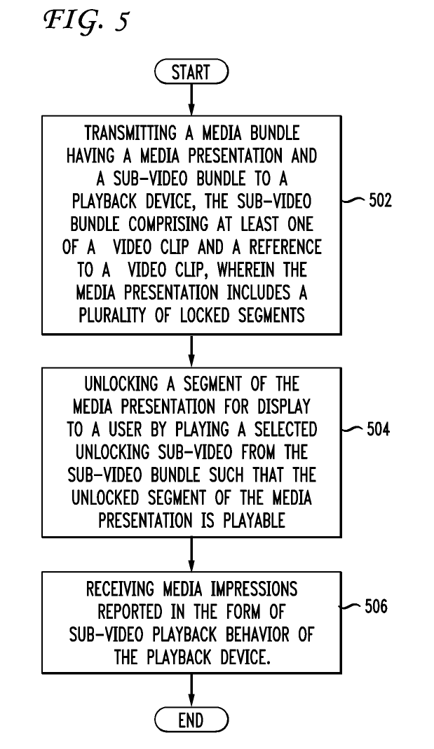

FIG. 5 illustrates an example method for presenting advertisements in a media presentation. At step 502 the system transmits a media bundle having a media presentation and a sub-video bundle to a playback device, the sub-video bundle including at least one of an vide clip and a reference to an video clip, wherein the media presentation includes a plurality of locked segments. Although the method applies to any kind of sub-video, one preferred embodiment uses advertising content for sub-videos. As such, the principles of the invention are discussed in terms of advertisements. In one aspect, a media bundle includes one or more of an episode file, a reference to an episode file, expiration information for the episode file, expiration information for one or more advertisements, metadata, advertisement break locations, and advertisement unlocking information. The media bundle can be transferred from an online playback device to an offline playback device. One example of an online playback device is an Internet-connected personal computer with iTunes software installed. The computer syncs the media bundle to an offline playback device, such as an iPod, via a Universal Serial Bus (USB) connection. The user can then disconnect the offline playback device from the computer and play the media bundle contents offline.

In one aspect, the system transfers a media bundle to an offline playback device for playback. The offline playback device provides mechanisms to unlock media segments by viewing advertisements. The offline playback device can deal with expired content in a number of ways. One way is to simply prevent any access to expired ads or expired episodes. Another way is to allow access to view expired ads and/or expired episodes once after displaying a warning such as “This content is expired. Please sync to download unexpired content.” The offline playback device may be synced wirelessly, via a physical connection such as a cable, or some combination. One existing example of how a sync interface works is the iTunes and iPod combination, where a computer with iTunes software syncs with an iPod via a dock or a USB cable. During the sync process statistics are transferred from the iPod to the computer, songs and other media are transferred from the computer to the iPod, software or firmware updates are installed on the iPod, etc. Other pairs of online/offline devices exist and the principles described herein are applicable to these other devices.

Advertisement break locations and expiration may be time-sensitive to play different ads depending on the date or time of playback. For example, an advertiser like Taco Bell specifies that their lunch ads are only to be played between 11:00 am and 1:30 pm on any day, whereas Dunkin Donuts only wants their ads played between 5:30 am and 9:00 am on weekdays. In these cases, advertisements expire temporarily but are reverted to an unexpired state at a later time. A firework vendor may specify that their ads only be played between June 15 and July 6. In this case, advertisements expire permanently and may even be deleted.

All or part of the media bundle can be protected by a digital rights management (DRM) scheme. Content providers can specify which episode assets are protected, if any. Advertisers can specify which ad assets are protected, if any. Apple's FairPlay is one exemplary DRM scheme of many.

We now return to FIG. 5 and the method embodiment. At step 504 the method includes unlocking a segment of the media presentation for display to a user by playing a selected unlocking sub-video from the sub-video bundle such that the unlocked segment of the media presentation is playable. For example, in the bar shown in FIG. 3, the first segment on the left was unlocked to begin with and the second segment from the left was unlocked after viewing the first ad break. In one variation, a user specifies a maximum content rating for advertisements similar to the ratings found in movies (G, PG, PG-13, R). For example, a G-equivalent rating can disallow ads for adult-related products or services that are inappropriate for children. The system can use other content ratings such as a personalized rating, ideological rating, religious rating, etc. An example of a religious rating is to disallow ads for coffee, tea, alcohol, tobacco, cigarettes, recreational activities on Sundays, etc. as per the beliefs of certain religious groups. An example of an ideological rating is to disallow ads for fur coats and restaurants that serve meat as per a member of an organization opposed to such products. An example of a personalized rating is to disallow ads for certain products which a viewer will not purchase or certain sellers which a viewer will not patronize. Preset content rating selections can be made available for use by anyone. For example, an organization may create a publicly available content rating selection and urge its members to apply it to their playback devices.

One example of when such a content rating feature is useful is a parent who downloads the animated feature “Wall*e” for their child to view, but doesn't want the child to view any inappropriate advertisements like beer commercials or suggestive commercials. The parent sets a G-equivalent rating for ads in the ad bundle. In online playback devices, multiple content ratings can be implemented for the same media bundle because inappropriate ads can be replaced by new downloaded ads directly. In offline playback devices, changing the content rating after it has been synced can be disallowed entirely. Another option for offline playback devices is to download a complete set of ads that would be compatible at each level of content rating or filter the offensive content out of ads where practicable. Yet another option for offline playback devices is refusing to display ads that exceed the maximum content rating. When this occurs, locked segments may remain locked or an exception can be granted to unlock the segment without viewing the entire ad break. Advertisement content rating systems can be applied broadly to all users of a device or can be user specific.

In one aspect, one or more segments of the episode are unlocked when the user pays a fee. The user can pay a fee up front when the media bundle is prepared and downloaded, can pay at a later time before viewing, or can pay while viewing the content. A user can pay a fee to unlock segments on behalf of a third party as a gift.

The system receives media impressions reported in the form of sub-video playback behavior of the playback device 506. A common viewing example is when a user sits down to watch the episode from start to finish with advertisements interspersed throughout. More elaborate variations are discussed above, such as where a user skips around in the media by manipulating the cursor in FIG. 3.

Online playback devices can directly report media impressions of the episode and/or the individual ads. The system can report periodically or as impression information is received. Offline playback devices store impression information in a cache because they have no way to report and no one to report to without a connection. When the offline playback device syncs with the online playback device, the offline playback device transfers impression information to the online playback device. The online playback device then reports that information back to the portal or online store.

In one aspect, reporting media impressions includes creating a database entry on a server for each media bundle sent to each device, transmitting to the server a journal file generated on the online playback device which identifies the playback device and when an episode bundle is played, and recording a media impression for each unique transmitted journal file which corresponds to the database entry. In this way, the impression is spoof resistant. If duplicate impressions are sent through an error in syncing, intentional misuse, or other reasons, the duplicate impressions are ignored because they are not unique. This impression reporting generates unique impressions for each playback device because each playback device has a unique journal file, such as a key, username, hash, etc. that is used in association with the impression reporting.

In another aspect, an impression policy determines what is reported back to the content provider. The impression policy is always the same mechanism that takes place on each playback device. The policy is predefined, unlike the ads which can be dynamic. This aspect is provided as a way to gather consistent, conforming media impression information for reporting to a larger audience measurement group such as Nielsen Media Research.

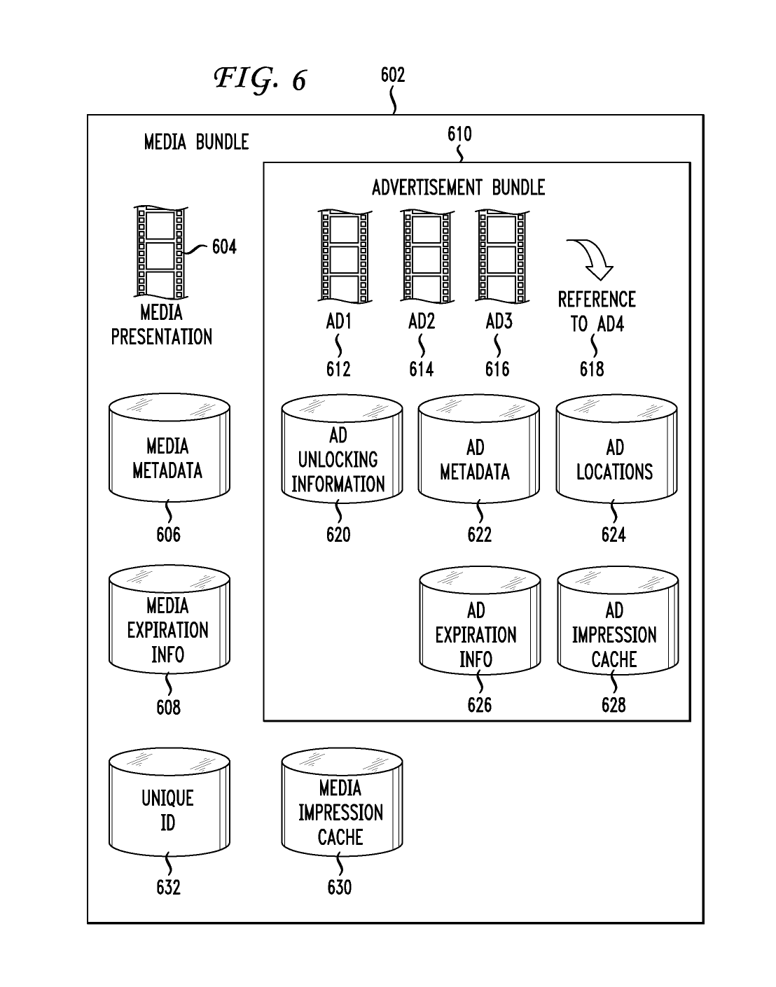

FIG. 6 illustrates an example media bundle 602. The media bundle contains a media presentation 604. The media presentation is one unified file. Copies of the same file are provided to all viewers regardless of the types of advertisements, amount of advertisements, etc. That is, a person who purchases the content ad-free gets the same file as a person who downloads and watches the content with ads. The media “payload” is the same; only the advertisement bundle differs. The media presentation can be a movie, a television episode, etc. The media presentation can be stored as a video file or represented by a reference to a remote location storing the video file. Such a reference can be an Internet address (such as rtsp://mediaserver.com/episode.mov), a symbolic link (such as under the Posix operating system standard), etc. In an offline playback device, Internet addresses are unusable, so the referenced file can be downloaded and stored on the offline playback device. The media bundle also includes media metadata 606 and media expiration information 608, as discussed above. For purchased content, media expiration information may be null or may indicate that the media never expires. One way to enforce expiration information is to simply delete expired content from the playback device. An advertisement bundle 610 also is stored within the media bundle 602. The advertisement bundle contains one or more ad files or references to ad files 612, 614, 616, 618. Some are shown as individual ad files 612, 614, 616 while one is shown as a reference to a file 618. The advertisement bundle 610 includes ad unlocking information 620, ad metadata 622, ad locations 624, ad expiration information 626, and an ad impression cache 628. Metadata can include instructions on how, where, and how many ads to display, if at all. The media bundle also includes a media impression cache 630. When impressions are reported, the unique ID 632 is included in some form to identify each impression on each playback device uniquely, thereby reducing the risk of spoofing a reporting database with false or inaccurate impression statistics.

A content provider can update the ad locations and individual ads in the advertisement bundle, even after transferring the bundle to an online or offline playback device. As ads expire, the system can replace expired ads with unexpired ads.

Embodiments within the scope of the present invention may also include computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the processes described herein may have application in online delivery of ad-supported public television shows to portable media players. Those skilled in the art will readily recognize various modifications and changes that may be made to the present invention without following the example embodiments and applications illustrated and described herein, and without departing from the true spirit and scope of the present invention.

1. A method of presenting sub-videos in a media presentation, the method comprising:
transmitting a media bundle having a media presentation and a sub-video bundle to a playback device, the sub-video bundle comprising at least one of a video clip and a reference to a video clip, wherein the media presentation includes a plurality of locked segments;
unlocking a segment of the media presentation for display to a user by playing a selected unlocking sub-video from the sub-video bundle such that the unlocked segment of the media presentation is playable; and
receiving media impressions reported in the form of sub-video playback behavior of the playback device.

2. The method of claim 1, wherein the media bundle comprises at least one of an episode file, a reference to an episode file, metadata, sub-video break locations, and sub-video unlocking information.

3. The method of claim 1, wherein the playback device is an online playback device.

4. The method of claim 3, wherein the media bundle is transferred by the online playback device to an offline playback device for playback.

5. The method of claim 2, wherein the media bundle further comprises episode expiration information and sub-video expiration information, such that the playback device will not display any portion of the media bundle when a sub-video in the sub-video bundle is expired or when the episode is expired.

6. The method of claim 1, wherein at least one segment of the episode is unlocked when the user pays a fee in lieu of playing a sub-video.

7. The method of claim 1, wherein at least part of the media bundle is protected by a digital rights management scheme.

8. The method of claim 1, wherein media impressions are reported by:
creating a database entry for each media bundle provided to each device on a server;
receiving at the server a journal file generated on the playback device which identifies the playback device and when an episode bundle is played; and
recording a media impression for each unique transmitted journal file which corresponds to the database entry.

9. A system for presenting advertisements in a media presentation downloadable to a media presentation client, comprising:
a content provider interface through which a content provider uploads media presentation information and advertisement information;
a media presentation assembler that assembles media bundles including media presentations and advertisement bundles from information uploaded by content providers through said content provider interface, the advertisement bundle comprising at least one of an advertisement and a reference to an advertisement; wherein a segment of the media presentation is unlocked for presentation to a user by playing a selected unlocking advertisement from the advertisement bundle such that the unlocked segment of the media presentation may be played to the user; and
a media impression logger that receives media impressions reported from playback devices in the form of advertisement playback behavior of the playback device, said media impressions being reviewable by said content providers.

10. The system of claim 9, wherein the media bundles comprise at least one of an episode file, a reference to an episode file, metadata, advertisement break locations, and advertisement unlocking information.

11. The system of claim 10, wherein the media bundles further comprise episode expiration information and advertisement expiration information, such that the playback device will not display any portion of the media bundle when an advertisement in said advertisement bundle is expired or when the episode is expired.

12. The system of claim 9, wherein the media impression logger comprises:
a module configured to create a database entry for each media bundle provided to each device on a server;
a module configured to receive at the server a journal file generated on the playback device which identifies the playback device and when an episode bundle is played; and
a module configured to record a media impression for each unique transmitted journal file which corresponds to the database entry.

13. A tangible computer-readable medium storing a computer program having instructions for presenting sub-videos in a media presentation, the instructions comprising:
transmitting a media bundle having a media presentation and a sub-video bundle to a playback device, the sub-video bundle comprising at least one of a video clip and a reference to a video clip, wherein the media presentation includes a plurality of locked segments;
unlocking a segment of the media presentation for display to a user by playing a selected unlocking sub-video from the sub-video bundle such that the unlocked segment of the media presentation is playable; and
receiving media impressions reported in the form of sub-video playback behavior of the playback device.

14. The tangible computer-readable medium of claim 13, wherein the media bundle comprises at least one of an episode file, a reference to an episode file, metadata, sub-video break locations, and sub-video unlocking information.

15. The tangible computer-readable medium of claim 13, wherein the playback device is an online playback device.

16. The tangible computer-readable medium of claim 15, wherein the media bundle is transferred by the online playback device to an offline playback device for playback.

17. The tangible computer-readable medium of claim 14, wherein the media bundle further comprises episode expiration information and sub-video expiration information, such that the playback device will not display any portion of the media bundle when a sub-video in the sub-video bundle is expired or when the episode is expired.

18. The tangible computer-readable medium of claim 13, wherein at least one segment of the episode is unlocked when the user pays a fee in lieu of playing a sub-video.

19. The tangible computer-readable medium of claim 13, wherein at least part of the media bundle is protected by a digital rights management scheme.

20. The tangible computer-readable medium of claim 13, wherein media impressions are reported by:
creating a database entry for each media bundle provided to each device on a server;
receiving at the server a journal file generated on the playback device which identifies the playback device and when an episode bundle is played; and
recording a media impression for each unique transmitted journal file which corresponds to the database entry.
